(19) United States
(12) Patent Application Publication
(10) Pub. No.: US 2005/0067472 A1
(43) Pub. Date: Mar. 31, 2005

(54) Method for connecting connection members to board

(76) Inventors: Tomonari Ohtsuki, Tokyo (JP); Yasue Yamazaki, Tokyo (JP)

Correspondence Address: BAKER & BOTTS, 30 ROCKEFELLER PLAZA, NEW YORK, NY, 10112, US

(21) Appl. No.: 10/996,152

(22) Filed: Nov. 23, 2004

(30) Foreign Application Priority Data
Jan. 22, 2003 (JP) 2003-13,146

(51) Int. Cl. B23K 31/02

(52) U.S. Cl. 228/248.1; 228/215

(57) ABSTRACT

A method for connecting connection members to through-holes of a board by soldering is disclosed. The board is press holded on its one side by a jig, and paste solder or solder in paste form is forced to flow into each of the through-holes of the board from the opposite side by a paste solder printing method using a printing mask. The printing mask is then removed under the condition of the paste solder being filled in the through-holes. After the connection members have been inserted in the through-holes of the board or have been urged against the board on the opposite side, the connection members are further connected to the board by reflow soldering, while the board is still continuously restrained or press holded on the one side by the jig. In this manner, it become possible to form any desired shapes of a plurality of solder connection portions connected to the board on the one side. As a result, the solder connection portions can be formed to be a predetermined height to prevent them from interfering deformation of contacts to provide a constant contact pressure of the contacts, thereby eliminating defective or failed connection.

### BACKGROUND OF THE INVENTION

The present invention relates to a method for connecting connection members in through-holes of a board, and more particularly to a method for connecting connection members to a board to form solder connection portions on one side of through-holes in any desired shapes.

In the case that connection members are connected in through-holes of a board in the past, paste solder or solder in paste form by heating is forced to fill into each of the through-holes from the side of the connection members by a paste solder printing method, and a printing mask is removed, leaving the paste solder filled in the through-holes. The connection members are then inserted in the through-holes or urged against the board and connected thereat as by reflow soldering.

The applicant of the present application proposed a connector disclosed in Japanese Patent Application Opened No. 2000-67,972 to attempt to provide the electrical connector capable of connecting a plurality of electric contacts to a plurality of electric contact elements at a time. In the electrical connector, a first connector plate and a second connector plate are brought into detachable abutment against each other to electrically connect the plurality of electric contacts placed on the first connector plate to the plurality of electric contact elements placed on a board arranged on the second connector plate. The second connector plate and the board thereon are formed with a plurality of slits partly surrounding the respective electric contact elements so that the electric contact elements are elastically supported in a cantilevered manner.

Such an electrical connector can achieve a particularly compact and simple construction as a whole, and can prevent any defective or failed contact between contacts and contact elements due to variances in height of the electric contacts, thereby ensuring a required impedance characteristic with ease. In other words, when the electric contacts are brought into contact with the electric contact elements, the electric contact elements are permitted to be displaced owing to the cantilever structure formed by the slits partly surrounding the electric contacts.

The applicant of the present application further proposed an electrical connector disclosed in Japanese Patent Application No. 2002-73,920 for the purpose of improving high speed transmission characteristic of double-sided connector having an elastomer including linear fine conductive wires embedded therein. The fine conductive wires embedded in the elastomer extend straight perpendicularly to both the surfaces of the elastomer so that both the ends of the fine conductive wires extend from both the surfaces of the elastomer. Diameters of both the ends of the conductive wires differ from those of the parts of the conductive wires embedded in the elastomer, thereby retaining the inherent possibility of connection to electric contacts and reducing the self-inductance of the wires.

Moreover, recesses are provided in the elastomer around its openings of apertures into which the conductive wires are inserted, and different diameter portions are provided in the conductive wires over their portions embedded in the elastomer to be more securely held in the elastomer. Each of electric contact elements is provided with a substantially hemispherical protrusion adapted to be in contact with an electric contact so as to achieve electrical connection therebetween. This electrical connector is like that disclosed in the Japanese Patent Application Opened No. 2000-67,972 in so far as the hemispherical protrusion is displaceable when contacting the mating electric contact. Further, connection members (conductive chains) are connected to through-holes of a flexible printed circuit board by soldering.

The applicant of the present application proposed a restraining jig disclosed in Japanese Patent Application No. 2002-228,840, although the object of the jig is different from that of the jig disclosed in the present application. The object of the Application No. 2002-228,840 is to provide a connecting method capable of easily connecting the connection portions of conductive members to a flexible printed circuit board, even if the connection portions of conductive members are covered by insulator. With the connection portions covered with insulator, the flexible printed circuit board is restrained by the jig to prevent it from moving away from the connection portions of the conductive members during the vapor reflow soldering stage.

The applicant of the present application further proposed a restraining jig disclosed in Japanese Patent Application No. 2002-228,911, although the object is different from that of the present invention. The object of Japanese Application No. 2002-228,911 is to provide a connecting method which is able to realize high speed signals, to perform connecting operation disregarding the length of conductive wires, to prevent a board from warping during connecting operation, to provide stable connection between conductive wires and flexible printed circuit board and to easily carry out connecting operation even if connection portions of the conductive members are covered by insulators. This patent literature further discloses a plurality of the fine conductive wires embedded in an elastomer and extending straight substantially perpendicularly to both the surfaces of the elastomer which is formed with recesses around openings of apertures into which the conductive wires are embedded. The flexible printed circuit board is restrained by a jig to prevent it from moving away from the elastomer, while the conductive wires are connected to the board by vapor reflow soldering.

As mentioned in the second paragraph, in the past, solder is forced into through-holes of a board, and after printed masks have been removed, connection members are inserted into the through-holes and connected thereat as by reflow soldering. When the connection members are inserted or urged into the through-holes of the board, however, the solder filled in the through-holes will be extruded onto the opposite side of the connection members. The amounts of the extruded solder are not constant so that shapes (heights) of the solder on the side of the electric contacts are not controlled.

With the connectors of Japanese Patent Application Opened No. 2000-67,972 and Japanese Patent Application No. 2002-73,920, the electric contact elements or the hemispherical protrusions on the electric contact elements are adapted to be displaced when they contact mating electric contacts, and the contact pressure (or force) is determined by a distance of the displacement. If the heights of solder connection portions are not desirable values, there can be premature contact between the solder connection portions and the mating connector before the electric contact elements contact mating electric contacts so that constant contact pressure between the contacts could not be obtained, resulting in defective or failed connection. As can be seen from FIG. 9, the contact pressure is determined by a difference H in height between a contact 12 and a solder connection portion 28, so that a constant contact pressure could not be obtained in the connectors of the two Japanese Applications because of variances in height of the solder connection portions.

On the other hand, the restraining jig in Japanese Patent Application No. 2002-228,840 is formed with through-holes (for through-holes of the board) at locations corresponding to the solder connection portions of the board. Therefore, solder connection portions having a constant height could not be formed so that the relevant problem would not be solved.

The restraining jig of Japanese Patent Application No. 2002-228,911 does not have through-holes (for through-holes of the board) at locations corresponding to the solder connection portions of the board illustrated in its FIG. 6 which is different from that of Japanese Patent Application No. 2002-228,840. In this case, however, the through-holes of the board are covered by a cover layer so that the respective through-holes become blind holes not having vents for air. Consequently, during the reflow soldering stage, circuits on the board would be often ruptured by thermal expansion of the air confined in the blind through-holes.

### SUMMARY OF THE INVENTION

It is an object of the invention to provide a method for connecting connection members to a board, which solves the above problems in the prior art and is able to obtain constant shapes (heights) of solder connection portions on the side of contacts after reflow soldering to achieve constant contact pressure between contacts and mating contacts, thereby eliminating defective or failed connection therebetween.

In order to accomplish the above object, the method for connecting connection members to a board according to the invention comprises steps of press holding or supporting the board on its one side by a jig; forcing paste solder to flow into each of the through-holes of the board press holded or restrained by the jig from the opposite side by a paste solder printing method using a printing mask; removing the printing mask in the state of the paste solder being filled in the through-holes; inserting or urging a connection members into or against the through-holes of the board on the opposite side, respectively; and further soldering the connection members to the board by reflow soldering, while the board is still continuously press holded or restrained on the one side by the jig, thereby enabling to form required shapes of a plurality of solder connection portions connected to the board on the one side.

In a preferred embodiment of the invention, shapes of the jig at the locations corresponding to the through-holes of the board are formed so as to obtain any required shapes of the solder connection portions on the one side. The shapes of the jig at the locations corresponding to the through-holes of the board are preferably formed in a shape selected from a group consisting of flat, raised and recessed shapes.

As can be seen from the above descriptions, the method for connecting connection members to a board according to the invention can bring about the following significant effects.
(1) According to the method of the invention, while a board is press holded or restrained on one side by a jig, paste solder is forced into through-holes of the board from the opposite side by a paste solder printing method using a printing mask, and after the printing mask has been removed, the connection members are inserted into the through-holes of the board while urging against the board on the opposite side and soldered to the board by reflow soldering, while the board is still continuously restrained on the one side by the jig. Therefore, the shapes of the plurality of solder connection portions on the one side of the board can be formed in a desired form.
(2) According to the invention, as the shapes of the solder connection portions on the one side of the board can be formed in a desired form, the shapes (heights and the like) of the solder connection portions on the one side after the reflow soldering can be invariably substantially the same or uniform. Therefore, a constant contact pressure between contacts and mating contacts can be achieved to eliminate defective or failed connection therebetween.
(3) According to the invention, only by working the surface of the jig at a plurality of locations into a required shape, the solder connection portions on the one side of the board can be formed in a required shape.
(4) According to the invention, the solder connection portions can be formed so as not to affect the deformation of the contacts when contacting mating contacts, thereby eliminating defective or failed connection.
(5) According to the invention, as the flexible printed circuit board is press holded or restrained by the jig to prevent it from moving away from the connection portions of the connection members during the reflow soldering step, the flexible printed circuit board and the connection portions of the members can easily be connected by soldering in a reliable manner.
(6) According to the invention, the flexible printed circuit board and the connection portions of the connection members can securely be connected by soldering with the aid of the restraint by the jig even if the flexible printed circuit boad tends to warp by attack of heat.

The invention will be more fully understood by referring to the following detailed specification and claims taken in connection with the appended drawings.

### BRIEF DESCRIPTION OF THE DRAWINGS

FIG. 1 is a front elevation of a dual-sided connector used in one embodiment of the invention;

FIG. 2 is a partly longitudinal sectional view of the connector shown in FIG. 1;

FIG. 3 is a front elevation of a jig used in the invention;

FIG. 4 is a partly longitudinal sectional view of a dual-sided connector restrained on both the side by the jigs shown in FIG. 3;

FIG. 5A is a partly sectional view illustrating the solder forced into a through-hole of a board from the opposite side by paste solder printing method;

FIG. 5B is a partly sectional view illustrating the state of FIG. 5A with printing masks removed;

FIG. 6A is a partly sectional view of the next step of inserting a connection member (pin having reduced diameter portions) into the through-hole of the board from the opposite side;

FIG. 6B is a partly sectional view of the same step as that in FIG. 6A, in which the connection member is urged against the board;

FIG. 7 is a front elevation of a jig as a modification of the jig shown in FIG. 3;

FIG. 8A is a sectional view similar to FIG. 6B, illustrating another shape of the solder connection portion;

FIG. 8B is a sectional view similar to FIG. 8A but illustrating a further shape of the solder connection portion; and

FIG. 9 is a partly sectional view for explaining a problems noted with prior art.

### DESCRIPTION OF THE PREFERRED EMBODIMENTS

The method for connecting connection members to a board or substrate according to the invention will be explained with reference to the drawings in the case of a double-sided connector, or a connector having contacts on both sides as a typical example. Before explaining the method, the double-sided connector will be explained by referring to the drawings.

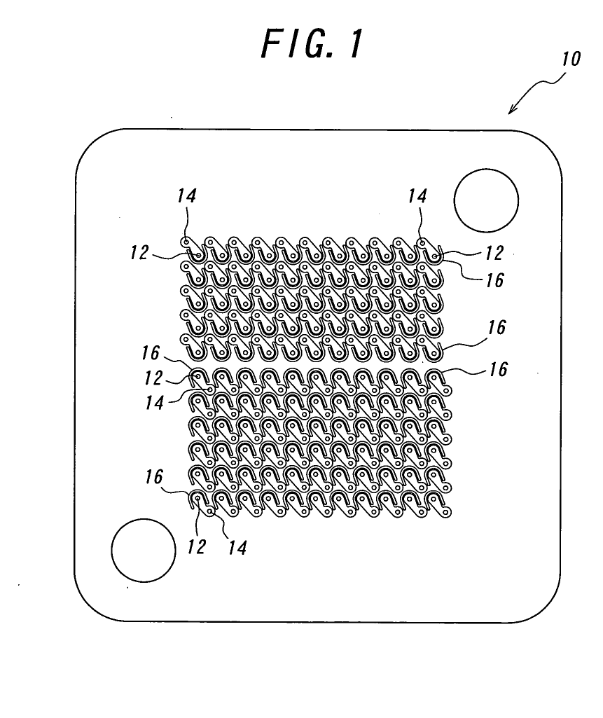

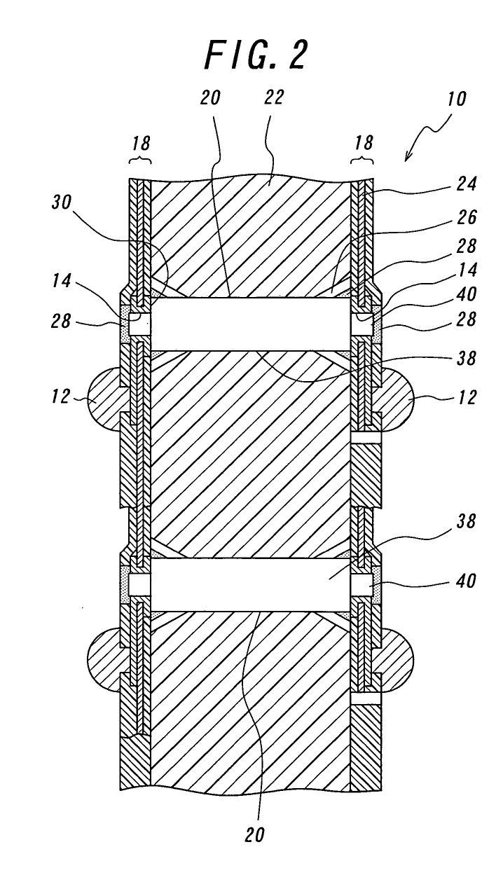

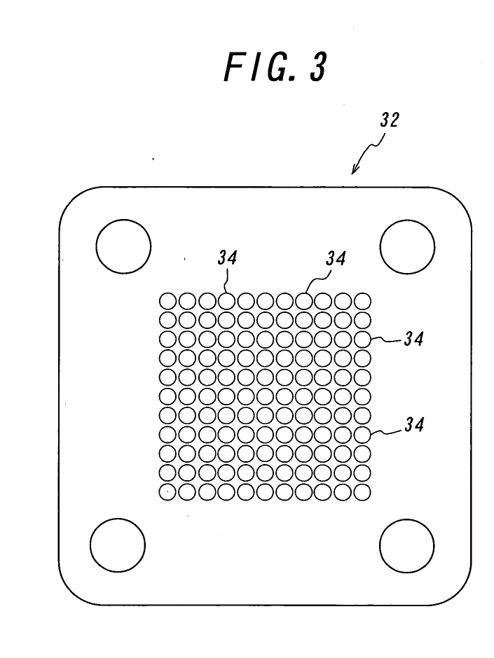

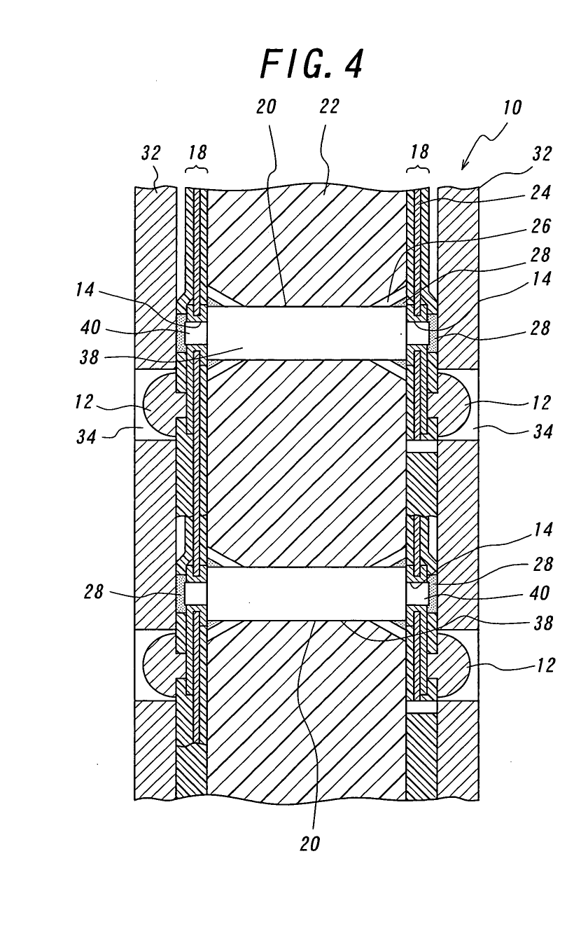

FIG. 1 illustrates in a front elevation the connector having contacts on both sides, whose partly longitudinal sectional view is FIG. 2. FIG. 3 shows a restraining jig in a front view to be used in carrying out the method. FIG. 4 is a partly longitudinal sectional view illustrating the connector being urged by the jigs.

The double-sided connector 10 mainly comprises flexible printed circuit boards (FPC) 18, an insulator 22 made of, for example, elastomer, and metal pins 20. The metal pins 20 are embedded in the insulator 22 on which both surfaces the flexible printed circuit boards 18 are mounted.

The metal pin 20 is a so-called stepped pin having a large diameter portion 38 to be embedded in the insulator 22 and reduced diameter portions 40 extending from the both opposite surfaces of the insulator 22, respectively. Reference numeral 30 denotes a shoulder between the reduced and large diameter portions 40 and 38 of the metal pin 20.

Each of the flexible printed circuit boards 18 is provided on its one surface with a required number of contacts 12 extending to contact mating contacts, respectively, and is formed with a required number of through-holes 14. On the surface of the flexible printed circuit board 18 there is provided a metal portion 24 such as a copper foil previously provided, for example, by the printed circuit pattern forming method which is one of circuit board producing methods.

In the case of the illustrated embodiment, pitches between the contacts 12 are 0.5 mm, while pitches between the through-holes 14 are also 0.5 mm. The reduced diameter portions 40 of the metal pins 12 are fitted in the respective through-holes 14 of the circuit boards 18 and fixed therein by soldering, thereby achieving electrical connection between both the circuit boards 18. In order to accomplish more reliable connection between the metal pins 12 and the printed circuit boards 18, further soldering is required between the shoulders 30 of the metal pins 20 and surface portions of the circuited boards facing to the insulator 22. In other words, the shoulders 30 of the metal pins 20 and rear or inner surfaces of the circuit boards are fixed by soldering.

The method for connecting connection members to boards according to the invention will be explained using flexible printed circuit boards 18 as boards and metal pins 20 as connection members.

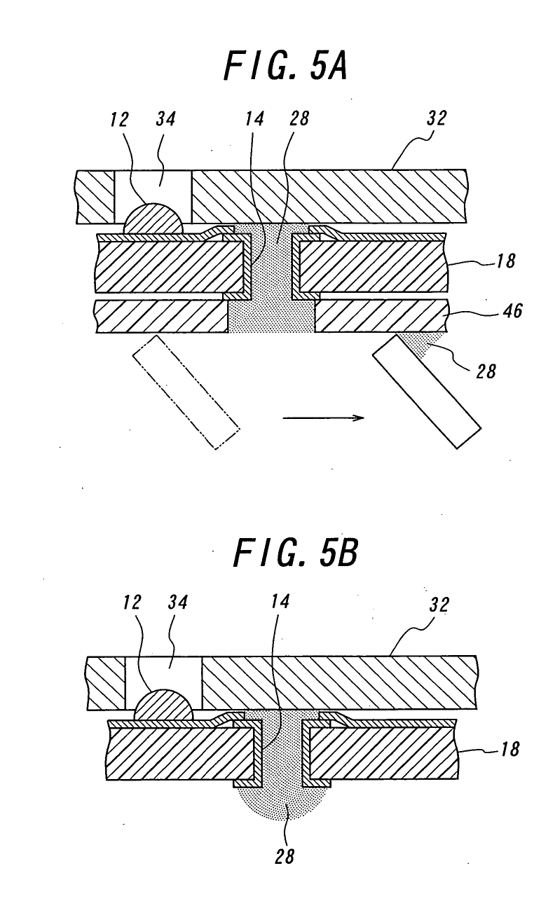

As shown in FIG. 5A, while a board is press holded on its one side by a jig 32, paste solder 28 or solder in paste form by heating is forced into a through-hole 14 of the board 18 from the opposite side of the jig 32 (on the side to connect the metal pin 20) by the paste solder printing method. Solders in paste form to be used herein may include lead tin alloy, soft solder containing a small amount of lead, and the like. Supplying the solder is performed by a printing method using a print mask (metal or plastic mask).

Thereafter, the print mask is removed in a state of the paste solder 28 filled in the through-hole 14, with the result that the paste solder will become a dome-shape on the opposite side of the jig 32 as shown in FIG. 5B.

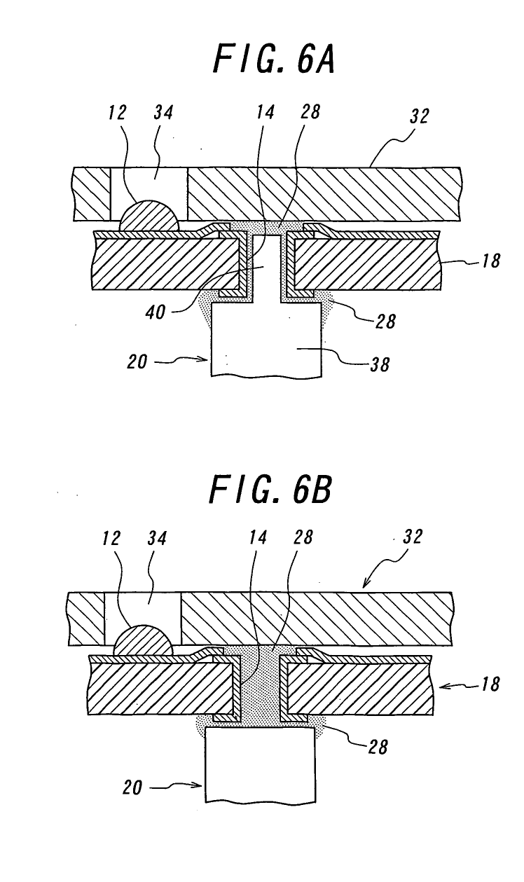

While the through-hole 14 is continuously press holded on one side by the jig 32, the connection member or metal pin 20 is inserted with its reduced diameter portion 40 into the through-hole 14 on the opposite side as shown in FIG. 6A or the dome-shaped solder is urged by the connection member or metal pin 20 as shown in FIG. 6B.

Finally, while the through-hole 14 is still continuously press holded on the one side by the jig 32, the connection member or metal pin 20 is further fixed to the board 18 by reflow soldering on the opposite side. In this manner, solder connection portions on the one side of the board are formed in desired shapes.

In the connecting method according to the invention, the restraint of the through-holes 14 on one side of the board 18 by the jig 32 is kept during the processes from the step of forcing the paste solder into the through-holes 14 of the board 18 by the paste solder printing method to the step of reflow soldering. Such a restraint on the one side of the board 18 by the jig 32 through the proceeding of these steps makes it possible to form the shapes of a plurality of solder connection portions on the one side substantially conforming to or coinciding with those of the jig 32. Consequently, it is also possible to form a plurality of solder connection portions substantially the same as in shape, height, outer diameter and the like. The shape, height and diameter of the solder connection portions may be suitably determined depending upon specifications desired by consumers or customers.

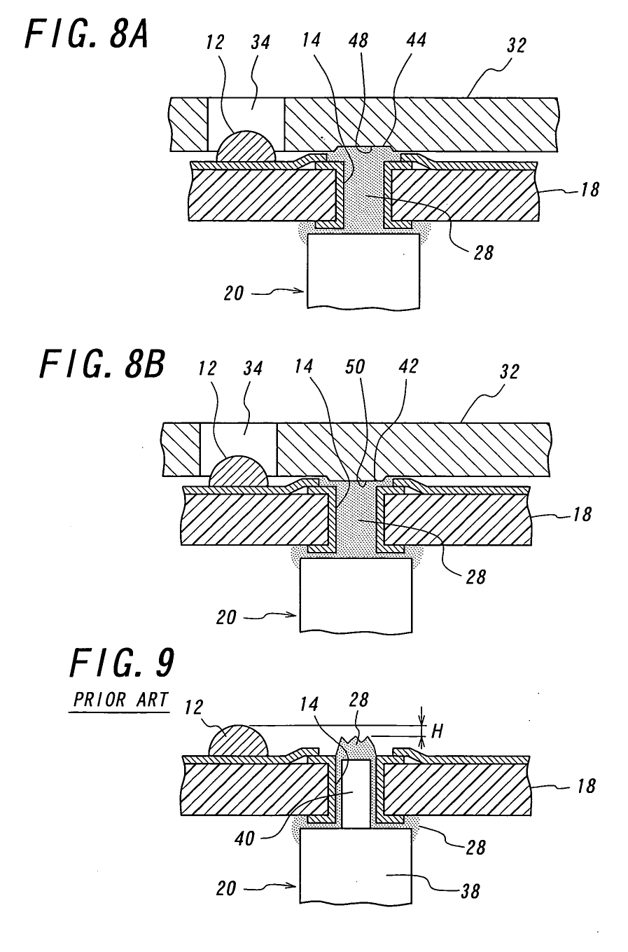

There are various shapes of the solder connection portions, for example, a flat shape as shown in FIGS. 5A and 5B, a flatly raised shape 44 as shown in FIG. 8A, and a flatly recessed shape 42 as shown in FIG. 8B. Such various shapes of the solder connection portions on the one side of the board can be easily obtained by corresponding formation of the jig 32.

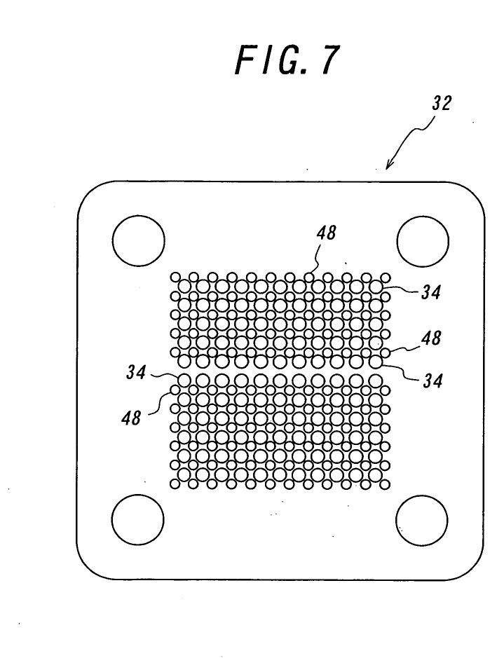

In addition to the above function of the jigs 32 shown in FIGS. 3 and 7, they will serve simultaneously to prevent the flexible printed circuit boards 18 from moving away from the shoulders 30 of the metal pins 20 during the connecting processes.

The jig 32 will be explained in detail hereinafter. The jig 32 is made of a metal and formed as by machining. The jig 32 is formed with a required number of through-holes 34 so as to receive a required number of contacts 12 to prevent their interference with the jig 32. The through-holes 34 may be about 0.01 to 0.08 mm larger in diameter than the contacts 12. The jigs 32 are fixed to the connector by threaded fasteners or clamps to prevent the boards 18 from moving from the insulator 22, and the assembly thus clamped is then transferred into an apparatus for reflow or vapor reflow soldering.

In the illustrated embodiment, the jigs 32 are preferably formed with the through-holes 14 so as to permit the jigs 32 to be commonly used for the boards 18 on the opposite sides in consideration of positions of the contacts on the opposite sides.

The jig 32 is further formed with worked portions, for example, flat recesses 48 in FIG. 8A and flat protrusions 50 in FIG. 8B at locations corresponding to the through-holes 14. In the case of flat upper surfaces of the solder connection portions, there is no need for the worked portions of the jig 32 corresponding to the through-holes 14. If the solder connection portions are in the form of the flat raised shape as in FIG. 8A, the jig 32 is worked to form flat recesses 48 at locations corresponding to the through-holes 14 of the board as shown in FIG. 7. The shape of the solder connection portions may be determined so as not affect the contact pressure (or deformation) of the contacts 12. In the case of the flatly raised shape 44 of the solder connection portions as shown in FIG. 8A, their height may be determined so as not to interfere with the deformation of the contacts.

While the invention has been particularly shown and described with reference to the preferred embodiments thereof, it will be understood by those skilled in the art that the foregoing and other changes in form and details can be made therein without departing from the spirit and scope of the invention.

1. A method for connecting connection members to through-holes of a board by soldering, comprising steps of:
press holding said board on its one side by a jig; forcing to flow paste solder into each of said through-holes of the board from the opposite side by a paste solder printing method using a printing mask; removing said printing mask in the state of the paste solder being filled in said through-holes; inserting or urging connection members into or against said through-holes of said board on the opposite side, respectively; and further soldering said connection members to said board by reflow soldering, while said board is still continuously press holded on said one side by said jig, thereby enabling to form required shapes of a plurality of solder connection portions connected to said board on said one side.

2. The method for connecting connection members to a board as set forth in claim 1 wherein shapes of said jig at locations corresponding to said through-holes of the board are formed so as to obtain said required shapes of the solder connection portions on said one side.

3. The method for connecting connection members to a board as set forth in claim 2 wherein said shapes of said jig at locations corresponding to said through-holes of the board are formed in a shape selected from a group consisting of flat, raised and recessed shapes.
